(19) United States
(12) Patent Application Publication
(10) Pub. No.: US 2025/0254636 A1
(43) Pub. Date: Aug. 7, 2025

(54) NEIGHBOR CELL MEASUREMENTS WITH NON-CELL-DEFINED SYNCHRONIZATION SIGNAL BLOCKS (NCD-SSB)

(71) Applicant: Apple Inc., Cupertino, CA (US)

(72) Inventors: Jie Cui, San Jose, CA (US); Yang Tang, San Jose, CA (US); Qiming Li, Beijing (CN); Haitong Sun, Saratoga, CA (US); Manasa Raghavan, Sunnyvale, CA (US); Xiang Chen, Campbell, CA (US); Hong He, San Jose, CA (US); Dawei Zhang, Saratoga, CA (US)

(21) Appl. No.: 18/857,528

(22) PCT Filed: Apr. 25, 2022
(86) PCT No.: PCT/CN2022/088922

§ 371 Date: Oct. 17, 2024

(51) Int. Cl. H04W 56/00; H04W 24/10; H04W 76/20

(52) U.S. Cl. CPC H04W 56/0015; H04W 24/10; H04W 76/20

(57) ABSTRACT

Techniques discussed herein can facilitate neighbor cell measurements with non-cell-defined synchronization signal blocks (NCD-SSB). One example aspect is a baseband processor of a user equipment (UE), including one or more processors configured to receive an indication of a NCD-SSB and a cell-defined (CD)-SSB (CD-SSB) configuration. The one or more processors further perform a measurement procedure to obtain a cell measurement value associated with a SSB wherein the SSB is one of the NCD-SSB or the CD-SSB. Subsequently, the one or more processors compare the cell measurement value with a threshold value; and perform measurement of a neighbor cell when the cell measurement value does not satisfy the threshold value.

### FIELD

The present disclosure relates to wireless technology including New Radio (NR) radio neighbor cell measurements based on non-cell-defined synchronization signal blocks (NCD-SSBs).

### BACKGROUND

Mobile communication in the next generation wireless communication system, 5G, or new radio (NR) network will provide ubiquitous connectivity and access to information, as well as the ability to share data, around the globe. 5G networks and network slicing will be a unified, service-based framework, that will target to meet versatile, and sometimes conflicting, performance criteria. 5G networks will provide services to vastly heterogeneous application domains ranging from Enhanced Mobile Broadband (eMBB) to massive Machine-Type Communications (mMTC), Ultra-Reliable Low-Latency Communications (URLLC), and other communications. In general, NR will evolve based on third generation partnership project (3GPP) long term evolution (LTE)-Advanced technology with additional enhanced radio access technologies (RATs) to enable seamless and faster wireless connectivity solutions.

### BRIEF DESCRIPTION OF THE DRAWINGS

FIG. 1 is an exemplary block diagram illustrating an example of user equipment(s) (UEs) communicatively coupled to a network in accordance with various aspects described herein.

FIG. 2 illustrates a measurement procedure for neighbor cell measurements based on non-cell defined synchronization signal blocks (NCD-SSB) associated with a serving cell measurement value for a network that includes a UE, a serving base station (BS), and a neighboring BS.

FIG. 3 illustrates a diagram of neighbor cell measurements based on a threshold value associated with a NCD-SSB and a cell defined-SSB (CD-SSB) configuration.

FIG. 4 is a table of radio resource control (RRC) IDLE/inactive mode SSB measurement threshold mapping options.

FIG. 5 is a table of RRC CONNECTED mode SSB measurement threshold mapping options.

FIG. 6 illustrates a flow diagram of an example method for neighbor cell measurements based on a serving cell measurement value associated with NCD-SSB/CD-SSB configurations for a UE.

FIG. 7 illustrates a flow diagram of an example method for neighbor cell measurements based on a serving cell measurement value associated with NCD-SSB/CD-SSB configurations for a BS.

FIG. 8 illustrates an example of an infrastructure equipment, in accordance with various aspects disclosed.

FIG. 9 illustrates an example of a UE or BS platform, in accordance with various aspects disclosed.

### DETAILED DESCRIPTION

As New Radio (NR) fifth generation (5G) and future communication standards develop, network flexibility and scalability can adapt new use cases to connect more devices, for example, reduced capability (RedCap) user equipments (UE) or devices. RedCap UEs can be UE devices with reduced capabilities including wearable devices, sensors, or other devices that have less stringent data requirements compared to, for example, enhanced mobile broadband (eMBB) devices. As such, a RedCap UE may have reduced frequency bandwidths that require accommodations in subcarrier spacing for synchronization signal block/physical broadcast channel block (SSB) used for cell search, selection, re-selection, and handover procedures. As such, the network (NW) can allocate different system bandwidths for RedCap UEs and non-RedCap UEs. With different system bandwidths for RedCap UEs and non-RedCap UEs, transmission of legacy SSBs, or cell-defined-SSBs (CD-SSBs), on an active bandwidth part (BWP) in the system bandwidth for non-RedCap UEs may potentially result in CD-SSBs being transmitted outside of an active BWP used by a RedCap UE due to different system bandwidth for the RedCap UE. In such instances, this may require the RedCap UE to tune to frequency bands outside of an active BWP of the RedCap UE to perform SSB measurements, resulting in performance degradation or power consumption. Accordingly, a second type of SSB, i.e., non-cell-defined-SSB (NCD-SSB), may be introduced for dedicated use by RedCap UEs to address this issue. With the coexistence of multiple SSB types, however, there may be instances where a UE detects either or both CD-SSBs and NCD-SSB, and solutions are disclosed herein for addressing UE and network operations when both CD-SSB and NCD-SSB are configured for a serving cell and/or a neighbor cell.

A neighbor cell measurement can be initiated by a handover or a cell-reselection procedure when a cell measurement value associated with a SSB does not satisfy a threshold value. Such a scenario can indicate that conditions to maintain cellular communications are not ideal and a new beam or cell should be selected. However, with the existence of multiple SSB types with differing bandwidths (e.g. the NCD-SSB and CD-SSB) from a serving cell, the RedCap UE needs to determine how to map the SSB types to potential measurement thresholds. Furthermore, methods to indicate the association of a SSB type to a threshold and corresponding UE and NW or base station (BS) behavior are required.

Various aspects of the present disclosure are directed towards neighbor cell measurements triggered by NCD-SSB. Mechanisms by which the RedCap UE associates a SSB type and the threshold value for IDLE/inactive mode or CONNECTED mode radio resource control (RRC) states are presented herein. Mechanisms include preconfigured mapping of SSB type to threshold values as well as mapping determined by a BS and signaled to the UE. Mechanisms by which the association of the SSB type and the threshold value are indicated to the RedCap UE based on the RRC state are presented herein. Mechanisms of UE and BS behavior when the CD-SSB and NCD-SSB are configured by the network are presented herein. Such information can be indicated by dedicated RRC signaling, system information, or power levels associated with the SSB type. As such, options that conserve network resources or optimize measurement procedures in the presence of multiple SSB types and multiple UE types are described. In one aspect the NCD-SSB can be selected to reduce system resources and streamline associated serving cell measurements. In another aspect, the CD-SSB can be selected which may result in frequency tuning by the RedCap UE to obtain the CD-SSB, however, the CD-SSB has the benefit of comprising complete cell information for serving cell measurements.

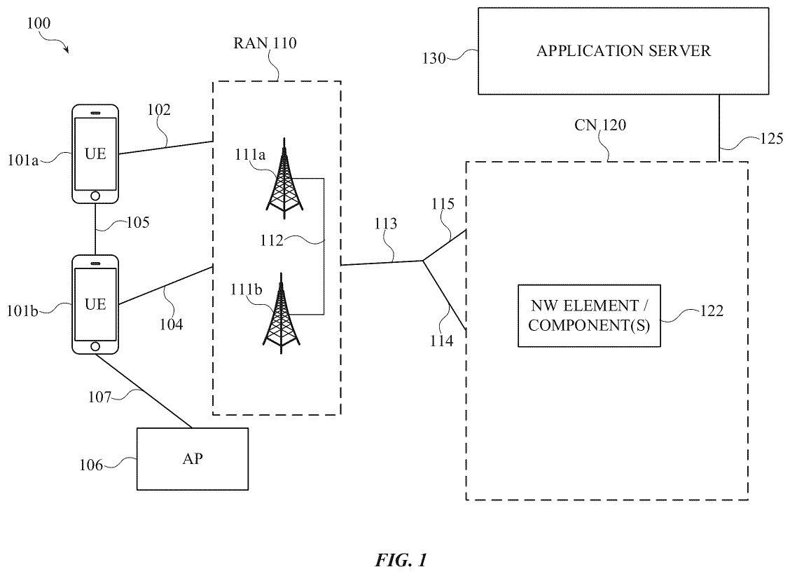

FIG. 1 illustrates example architecture of a wireless communication system 100 of a network that includes UE 101a and UE 101b (collectively referred to as “UEs 101” or “UE 101”), a radio access network (RAN) 110, and a core network (CN) 120. The UEs communicate with the CN 120 by way of the RAN 110. In aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G system 100, and the term “E-UTRAN” or the like can refer to a RAN 110 that operates in an LTE or 4G system 100. The UEs 101 utilize connections (or channels) 102 and 104, respectively, each of which comprises a physical communication interface/layer. Channels 102 and 104 can facilitate one or more of licensed or unlicensed communication bands between the UE 101 and the RAN 110.

Alternatively, or additionally, each of the UEs 101 can be configured with dual connectivity (DC) as a multi-RAT or multi-Radio Dual Connectivity (MR-DC), where a multiple Rx/Tx capable UE may be configured to utilize resources provided by two different nodes (e.g., 111a, 111b, 112, or other network nodes) that can be CONNECTED via non-ideal backhaul, one providing NR access and the other one providing either E-UTRA for LTE or NR access for 5G, for example.

Alternatively, or additionally, each of the UEs 101 can be configured in a CA mode where multiple frequency bands are aggregated amongst component carriers (CCs) to increase the data throughput between the UEs 101 and the nodes 111a, 111b. For example, UE 101a can communicate with node 111a according to the CCs in CA mode. Furthermore, UE 101a can communicate with nodes 111 in a DC mode simultaneously and additionally communicate with each node of nodes 111 in the CA mode.

In this example, the connections 102 and 104 are illustrated as an air interface to enable communicative coupling. In aspects, the UEs 101 can directly exchange communication data via a ProSe interface 105. The ProSe interface 105 can alternatively be referred to as a sidelink (SL) interface 105 and can comprise one or more logical channels. In other aspects, the ProSe interface 105 can be a direct (peer-to-peer) communication.

The RAN 110 can include one or more access nodes or RAN nodes 111a and 111b (collectively referred to as “RAN nodes 111” or “RAN node 111”) that enable the connections 102 and 104. As used herein, the terms “access node,” “access point,” or the like can describe equipment that provides the radio baseband functions for data and/or voice connectivity between a network and one or more users. These access nodes can be referred to as a base station (BS), next generation base station (gNBs), RAN nodes, evolved next generation base station (eNBs), NodeBs, RSUs, Transmission Reception Points (TRxPs) or TRPs, and so forth.

In aspects where the system 100 is a 5G or NR system, the interface 112 can be an Xn interface 112. The Xn interface is defined between two or more RAN nodes 111 (e.g., two or more gNBs and the like) that connect to 5GC 120, between a RAN node 111 (e.g., a gNB) connecting to 5GC 120 and an eNB, and/or between two eNBs connecting to 5GC 120.

The BS 111a and 111b can be a serving BS 111a and a neighbor BS 111b (or neighbor cell). Accordingly, the UE 101 can receive the indication of CD-SSB and NCD-SSB configuration by connections 102 or 104 from the serving BS 111a.

The UE 101 and the RAN node 111 may utilize a Uu interface to exchange control plane data via a protocol stack comprising the PHY layer (e.g., layer 1 (L1)), the MAC layer (e.g., layer 2 (L2)), the RLC layer, the PDCP layer, and the RRC layer (e.g., layer 3 (L3)). The Uu interface can be one or more of connections 102 and 104.

In aspects, the CN 120 can be a 5GC (referred to as “5GC 120” or the like), and the RAN 110 can be CONNECTED with the CN 120 via a next generation (NG) interface 113. In embodiments, the NG interface 113 can be split into two parts, a NG user plane (NG-U) interface 114, which carries traffic data between the RAN nodes 111 and a User Plane Function (UPF), and the S1 control plane (NG-C) interface 115, which is a signaling interface between the RAN nodes 111 and Access and Mobility Management Functions (AMFs).

In aspects, where CN 120 is an evolved packet core (EPC) (referred to as “EPC 120” or the like), the RAN 110 can be CONNECTED with the CN 120 via an S1 interface 113. In embodiments, the S1 interface 113 can be split into two parts, an S1 user plane (S1-U) interface 114, which carries traffic data between the RAN nodes 111 and the S-GW, and the S1-MME interface 115, which is a signaling interface between the RAN nodes 111 and MMEs.

The UE 101 can perform a measurement procedure to obtain the cell measurement value to compare to the threshold value by connections 102 or 104. Furthermore, when the measurement value does not satisfy the threshold value, the UE 101 can perform a measurement of the neighbor BS 111b by connections 102 or 104.

The RAN 110 is shown to be communicatively coupled to a core network—in this aspect, CN 120. The CN 120 can comprise a plurality of network components 122 (or network devices), which are configured to offer various data and telecommunication services to customers/subscribers (e.g., users of UEs 101) that are CONNECTED to the CN 120 via the RAN 110.

### Neighbor Cell Measurement Triggering with NCD-SSB

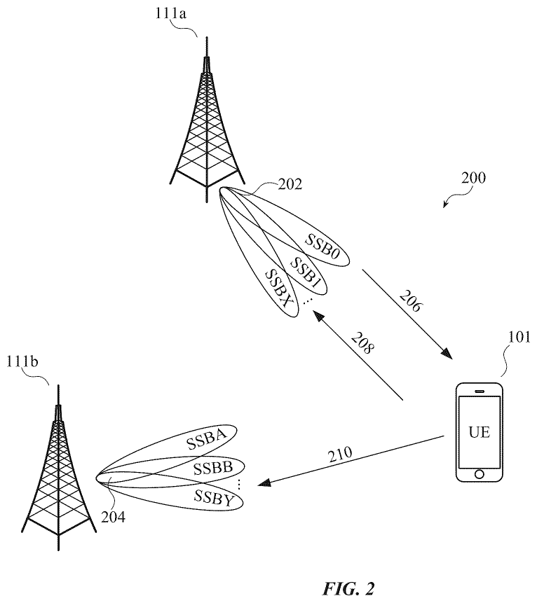

FIG. 2 illustrates a measurement procedure 200 for neighbor cell measurements based on NCD-SSB associated with a serving cell measurement value for a network that includes a UE 101, a serving BS 111a, and a neighboring BS 111b.

In the measurement procedure 200, the UE 101 can be the UE 101a or UE 101b of FIG. 1. In some aspects, the UE 101 is a RedCap UE, a legacy UE, or a UE other than a RedCap UE, and referred to generally as “UE” hereafter. UE 101 can, for example, be a reduced capability device including wearable devices, sensors, or other devices that have reduced data requirements compared to other UE devices. The serving BS 111a can be the BS 111a of FIG. 1 and can also be referred to as a serving cell. The neighboring BS 111b can be the BS 111b of FIG. 1 and can also be referred to as a neighboring cell, neighbor cell, or neighbor BS.

To support UEs with reduced capabilities, the BS can configure NW support for different types of SSBs, for example, NCD-SSB and CD-SSB. The CD-SSB can include a minimum system information (MSI) a master information block (MIB), and a system information block (SIB). The NCD-SSB can include partial cell information comprised in the MSI, MIB, and SIB. For example, the NCD-SSB can include partial cell information from the MIB, and include SIB1, or another combination of full or partial information comprised in the CD-SSB. As such, the NCD-SSB can occupy a reduce frequency bandwidth and fit within an active bandwidth part (BWP) or a monitored BWP of a RedCap UE. As the NCD-SSB can be within a BWP of the RedCap UE, the RedCap UE may not need to perform RF tuning to measure or receive the NCD-SSB, whereas the RedCap UE may need to perform RF tuning to measure or receive the CD-SSB that may reside outside of the BWP of the RedCap UE. The NCD-SSB can enable reduction of system message transmissions thereby saving network overhead and support minimum power or bandwidth configurations of UE 101.

At 206, the serving BS 111a transmits an indication that the serving BS 111a is configured for CD-SSB and NCD-SSB. The indication of CD/NCD SSB configuration communicates to the UE that multiple SSB types are discoverable in beams 202 of the serving BS 111a. As such, the UE 101 can configure a corresponding mapping of SSB type to a threshold value for a measurement procedure that can trigger neighboring BS 111b measurements. The indication of CD/NCD SSB configuration can be transmitted by the serving BS 111a to the UE 101 in a system information (SI) message when the UE 101 is configured for an IDLE or inactive RRC state, or dedicated RRC signaling when the UE 101 is configured for a CONNECTED RRC state. In some aspects the CD-SSB and NCD-SSB are comprised in system information signaling when indicated to the UE 101.

The UE 101 can determine a mapping between the SSB type and the threshold value based on an indication from the serving BS 111a, prior configuration by the NW, or a pre-configured mapping. Details of the mapping between SSB type and the measurement value are discussed further herein. The UE 101 can compare a cell measurement value, for example, reference signal received power (RSRP) or reference signal received quality (RSRQ) associated with the SSB type and the threshold value. In this aspect, the SSB type, such as the CD-SSB or NCD-SSB are associated with the threshold value. When the threshold value is not satisfied by the cell measurement value, the UE 101 can perform a measurement procedure of neighbor BS 111b. A measurement procedure 208 for the UE 101 is performed to obtain the cell measurement value associated with the SSB from the serving BS 111a. The measurement procedure 208 can include measuring at least one SSB type associated with at least one of SSB0 through SSBX of serving BS 111a.

When the cell measurement value associated with the SSB from the serving BS 111a does not satisfy the threshold value, the UE 101 may determine to perform a beam or cell re-selection procedure. As such, at 210, the UE 101 can perform a measurement of the neighbor BS 111b, for example, beams 204 comprising SSBA through SSBY. The measurement of the neighbor BS 111b can be an intra-frequency, inter-frequency, or an inter-radio access technology (RAT) measurement. The measurement of neighbor BS 111b can include measuring at least one SSB type associated with at least one of SSBA through SSBY of neighbor BS 111b.

Whether the UE 101 uses the CD-SSB or NCD-SSB for cell measurements in the measurement procedure of serving BS 111a can provide specific network benefits. For example, if the UE 101 performs NCD-SSB based measurements, the UE 101 can save resources by avoiding radio frequency (RF) re-tuning if the NCD-SSB is comprised in the active BWP of the UE 101. However, the NCD-SSB may not include full cell information desired for measurements. If the UE 101 performs CD-SSB based measurements, the UE 101 will have full cell information for measurements. However, the CD-SSB may not reside in the active BWP or monitored BWP of the UE 101, and may partially or fully reside outside of UE 101's active BWP or monitored BWP. As such, to complete measurements of the serving BS 111a based on CD-SSB, the UE 101 may need to perform a RF tuning/re-tuning/reconfiguration procedure to complete the measurement which would add time to the measurement procedure and reduce UE 101's battery. Solutions provided herein describe mapping between the SSB type and the threshold value to trigger neighbor BS 111b measurements, indication configurations for the mapping, and associated UE 101 and serving BS 111a behavior.

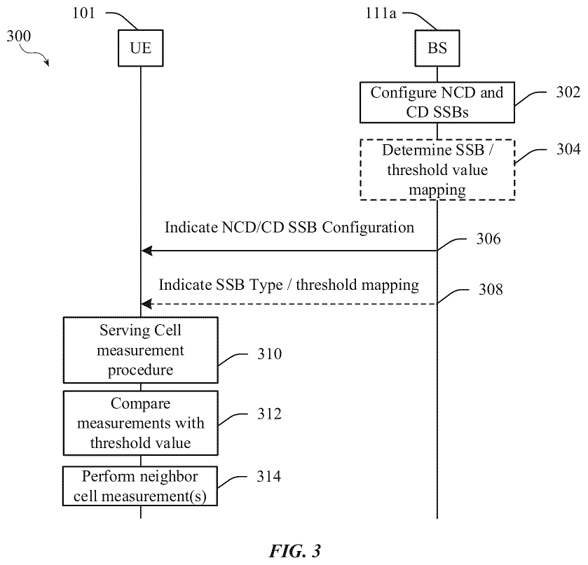

FIG. 3 illustrates a diagram 300 of neighbor cell measurements based on a threshold value associated with a NCD-SSB and a CD-SSB configuration. FIG. 3 corresponds to aspects of FIG. 2 where FIG. 3 depicts details of configuration and signaling events, for example, indication that BS 111a is configured for CD/NCD SSB at 206, measurement procedure at 208, and measurement of neighbor BS 111b at 210. The UE 101 can be configured for a RRC IDLE/inactive mode or CONNECTED mode. At 302, the serving BS 111a configures a NCD-SSB and CD-SSB. At 306 the BS 111a indicates the NCD-SSB and CD-SSB configuration of the serving BS 111a to the UE 101. The indication of the NCD-SSB and CD-SSB configuration communicates to the UE 101 that different SSB types are available in beams of the serving BS 111a.

The indication of NCD/CD-SSB configuration can be communicated to the UE 101 through system information (SI) that may, for example, be comprised in a broadcast control channel (BCCH) or downlink signaling when the UE 101 is in an RRC IDLE or inactive state. The indication of NCD/CD-SSB configuration can be communicated to the UE 101 through system information (SI), downlink signaling, or dedicated RRC signaling when the UE 101 is in a CONNECTED state.

As such, the UE 101 can perform mapping of the SSB type for measurements of the serving BS 111a and the threshold value autonomously for the measurement procedure at 310, by a preconfiguration, or based on an indication from the serving BS 111a and is discussed further herein. The type of threshold value depends on the RRC mode or state of the UE 101 and is discussed further herein. The UE 101 can be configured with one or more threshold values, and the one or more threshold values can be indicated to the UE 101 by the serving BS 111a or configured by other means.

In some examples, the serving BS 111a indicates the mapping of the SSB type associated with the cell measurement value for the measurement procedure at 310, and the serving BS 111a determines the SSB type to threshold value mapping at 304. At 308, the BS 111a can indicate the SSB type and threshold value mapping to the UE 101. Aspects of events 302, 304, 306 and 308 correspond to event 206 of FIG. 2.

At 310, the UE 101 can trigger or schedule a measurement procedure of the serving BS 111a based on the CD-SSB or NCD-SSB. The measurement procedure includes obtaining a cell measurement value associated with the SSB (e.g. SSB type, CD-SSB/NCD-SSB) and the threshold value. In this aspect, the UE 101 will measure one or more of a signal quality, power level, strength indicator, or the like from a beam of the serving BS 111a associated with the SSB. In some examples, the measurement procedure includes a single threshold value associated with a single SSB and single cell measurement value. In other examples, the measurement procedure includes a plurality of threshold values associated with a single SSB and plurality of cell measurement values. In further examples, the measurement procedure includes a plurality of cell measurement values associated with a plurality of SSBs and a plurality of associated threshold values. Thus the UE 101 will perform measurements of the serving BS 111a according to the number of configured SSBs and threshold values. Aspects of events 310 and 312 correspond to measurement procedure 208 of FIG. 2.

At 312, the UE 101 compares the cell measurement value to the threshold value associated with the SSB type. When the cell measurement value does not satisfy the threshold value, the UE 101 can perform neighbor cell measurement(s) at 314. The neighbor cell measurements can include measurements of the neighbor BS 111b and can include intra-frequency, inter-frequency, or inter-RAT measurements for a cell or beam selection or reselection procedure, or cell handover procedure. Aspects of event 314 correspond to event 210 of FIG. 2.

Aspects of diagram 300 provide solutions for UE 101 (e.g. RedCap UEs) to trigger neighbor cell measurements when a cell measurement value of a serving BS 111a associated with the CD-SSB or NCD-SSBs does not satisfy a threshold value. The solutions provided in diagram 300 provide options that conserve network resources or optimize measurement procedures in the presence of multiple SSB types and considering UE capabilities.

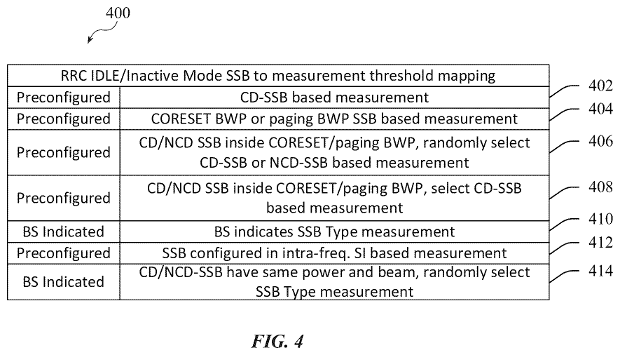

FIG. 4 is a table 400 of RRC IDLE/inactive mode SSB measurement threshold mapping options.

Table 400 provides solutions for how the UE 101 can associate threshold values, measurement values, and the SBB type. Table 400 is in the context of a UE 101 in a RRC IDLE or inactive mode, thus the threshold value(s) are associated with the RRC IDLE or inactive mode. As discussed previously, the measurement procedure can include one or more threshold values. For RRC IDLE or inactive modes, the one or more threshold values can be triggered when a cell selection receive level value (Srxlev) does not satisfy the threshold value or when a cell selection quality value (Squal) does not satisfy the threshold value. The Srxlev can correspond to a RSRP value and the Squal can correspond to a RSRQ value. In this aspect, the cell measurement value can be or correspond to the Srxlev or Squal. The one or more threshold values can include the following: S_{intraSearchP} which specifies the Srxlev threshold for intra-frequency measurements, S_{intraSearchQ} which specifies the Squal threshold for intra-frequency measurements, S_{nonIntraSearchP} which specifies the Srxlev threshold for inter-frequency and or inter-RAT measurements, and S_{nonIntraSearchQ} which specifies the Squal threshold for inter-frequency and inter-RAT measurements.

The neighbor cell measurements at 314 of FIG. 3 can be performed when the comparison between the cell measurement value and threshold value provides one or more of the following outcomes. A first outcome where Srxlev is less than S_{intraSearchP}, and the UE 101 performs intra-frequency measurements of the serving BS 111a. A second outcome where Squal is less than S_{intraSearchQ}, and UE 101 performs intra-frequency measurements of the serving BS 111a. A third outcome where Srxlev is less than S_{nonIntraSearchP}, and the UE 101 performs one or more of inter-frequency or inter-RAT measurements of the serving BS 111a. A fourth outcome where Squal is less than S_{nonIntraSearchP}, and the UE 101 performs one or more of inter-frequency or inter-RAT measurements of the serving BS 111a. The UE 101 can determine to configure one or more of the threshold values based on a preconfiguration, autonomously, or based on a measurement configuration from the serving BS 111a.

In instances where both CD-SSB and NCD-SSB are configured in the serving cell, the measurement procedure, including which SSB type the measurement thresholds described above with respect to FIG. 4 are associated with, to obtain the cell measurement value in IDLE or inactive mode can be performed according to the following options:

In a first option 402, that can be, in some instances, preconfigured at the UE 101, the UE 101 performs the CD-SSB based measurement procedure to obtain the cell measurement value (i.e., the UE 101 does not attempt to measure NCD-SSB). In this option, the UE 101 may need to perform a RF tuning/re-tuning/re-configuration to obtain the CD-SSB as the CD-SSB may reside outside of the active BWP of the UE 101. In this aspect, the UE 101 performs the RF tuning procedure to tune to the frequency point of the CD-SSB. As such, the first option 402 may provide the UE 101 with full SSB information for the measurement procedure at the potential trade-off of increased signaling and battery usage by UE 101.

In a second option 404, that can be, in some instances, preconfigured at the UE 101, the UE 101 performs the measurement procedure based on a SSB comprised in a BWP where the UE 101 monitors for a control resource set (CORESET) or a BWP where a paging resource is monitored. In other words, the UE 101 may measure an SSB based on whether the SSB, regardless of type, is contained in an active CORESET or paging BWP, and not measure an SSB, regardless of type, if it is located outside of the active CORESET or paging BWP. The CORESET BWP is the paging BWP which the UE 101 monitors, for control or paging messages expected to be received within the CORESET or paging resources, within a bandwidth of the UE 101. When the measurement procedure is based on the SSB comprised in the CORESET BWP, then the SSB may be in the bandwidth monitored by UE 101. As such, the UE 101 may not need to perform the RF tuning configuration to obtain the SSB (CD-SSB/NCD-SSB) when the SSB is comprised in the CORESET BWP or paging BWP.

In a third option 406, that can be, in some instances, preconfigured at the UE 101, where the CD-SSB and NCD-SSB are in the CORESET or paging BWP, the UE 101 performs the measurement procedure based on a random selection of the CD-SSB or NCD-SSB. When both the CD-SSB and NCD-SSB reside within the CORESET or paging BWP of the paging resource, the UE 101 can save processing power by randomly choosing one of the CD-SSB or NCD-SSB. In this aspect, the UE 101 conserves resources by utilizing minimal processing in choosing one of the CD-SSB or NCD-SSB.

In a fourth option 408, that can be, in some instances, preconfigured at the UE 101, where the CD-SSB and NCD-SSB are in the BWP of the CORESET or paging resource, the UE 101 performs the measurement procedure based on the CD-SSB. The fourth option 408 may provide the UE 101 with full SSB information for the measurement procedure relative to the third option 406.

In a fifth option 410, that can be, in some instances, indicated by the serving BS 111a, the UE 101 performs the measurement procedure based on one of the CD-SSB or NCD-SSB indicated by the serving BS 111a. The BS 111a can indicate one of the CD-SSB or NCD-SSB, for example, in a system information block (SIB) or a cell threshold configuration comprised in the SIB. The fifth option 410 can correspond to events 304 and 308 of FIG. 3. The fifth option 410 allows the serving BS 111a to designate the SSB type for the measurement procedure based on the serving BS 111a knowledge of UE 101 capability and resource allocation of SSBs to best optimize network signaling and mobility performance. As such, the BS 111a can indicate the CD-SSB or NCD-SSB based on a configuration of the power levels associated CD-SSB or NCD-SSB to trigger neighbor BS 111b measurements according to network optimization or mobility performance.

In a sixth option 412, the UE 101 performs the measurement procedure based on a SSB configured in an intra-frequency measurement object (e.g., system information). In this option, the network will configure SSB (CD-SSB or NCD-SSB), using the intra-frequency measurement object, within an intra-frequency band with respect to other measurements or communications that are already being performed by the UE 101. As such, the UE 101 does not need to perform RF tuning to a different frequency band (e.g., inter-frequency band) to measure the SSB and thus conserves resources and signaling.

In a seventh option 414, that can be indicated by the serving BS 111a, the serving BS 111a configures a same power level and beam for the CD-SSB and NCD-SSB. As such, the UE 101 detects the CD-SSB and NCD-SSB in a same beam with the same power level from the same cell (e.g. BS 111a). When the UE 101 detects both SSB types in this manner, the UE can perform the measurement procedure based on a random selection of the CD-SSB or NCD-SSB. The BS 111a configuring a same power level and beam for the CD-SSB and NCD-SSB simplifies the UE 101 determination process for which SSB to use. As such, the UE 101 can select the CD-SSB or NCD-SSB in a more flexible manner (e.g. randomly).

In some embodiments, the measurement procedure performed by the UE can be configured to obtain one or more measurement values according to the mapping options above. For example, the UE 101 can obtain measurement values associated with one or more of S_{intraSearchP}, S_{intraSearchQ}, S_{nonIntraSearchP}, Or S_{nonIntraSearchQ}. In some options, for example, the second option 404, third option 406, fifth option 410, sixth option 412, or seventh option 414, the UE 101 can use the same SSB type based measurement for more than one measurement value, or can use a different SSB type based measurement for more than one measurement value. As a non-limiting example, the UE 101 configured for the third option 406, could obtain a first measurement value for S_{intraSearchP} based on the CD-SSB and could obtain a second measurement value for S_{intraSearchQ} based on the NCD-SSB.

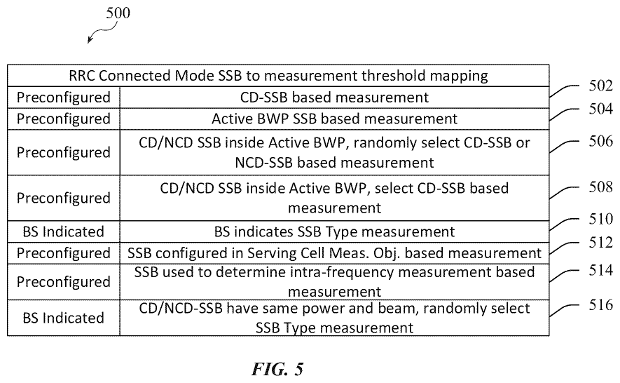

FIG. 5 is a table 500 of RRC CONNECTED mode SSB measurement threshold mapping options.

Table 500 provides solutions for how the UE 101 can map or associate the threshold value, the measurement value, and the SBB type. Table 500 is in the context of a UE 101 in a RRC CONNECTED mode, thus the threshold value is associated with the RRC CONNECTED mode. For the RRC CONNECTED mode, the threshold value can be a RSRP threshold value indicated in dedicated RRC signaling such as a measurement configuration, for example, a s-MeasureConfig element within a MeasConfig information element. For RRC CONNECTED mode, the threshold value can be triggered when the RSRP threshold value is not satisfied by the measurement value. The RSRP threshold value can correspond to intra-frequency measurements, inter-frequency measurements, or inter-RAT measurements. The UE 101 can determine to configure the threshold value based on a preconfiguration, autonomously, or based on a measurement configuration from the serving BS 111a.

In instances where both CD-SSB and NCD-SSB are configured in the serving cell, the measurement procedure, including which SSB type the RSRP threshold value are associated with, to obtain the cell measurement value in CONNECTED mode can be performed according to the following options:

In a first option 502, that can be preconfigured at the UE 101, the UE 101 performs the CD-SSB based measurement procedure to obtain the measurement value (i.e., the UE 101 does not attempt to measure NCD-SSB). In this option, the UE 101 may need to perform a RF re-configuration to obtain the CD-SSB as the CD-SSB may reside outside of the active BWP of the UE 101. In this aspect, the UE 101 performs the RF tuning procedure to tune to the frequency point of the CD-SSB. As such, the first option 502 may provide the UE 101 with full SSB information for the measurement procedure at the potential trade-off of increased signaling and battery usage by UE 101.

In a second option 504, that can be preconfigured at the UE 101, the UE 101 performs the measurement procedure based on a SSB comprised in an active BWP of the serving BS 111a and UE 101, and the UE 101 performs the measurement procedure based on the SSB type in the active BWP. In the second option 504, the UE 101 avoids RF tuning to detect the SSB as the SSB is in the active BWP of the UE 101, and thus the UE 101 can save power and resources. Either the CD-SSB or NCD-SSB can be in the active BWP.

In a third option 506, that can be preconfigured at the UE 101, the CD-SSB and NCD-SSB are in the active BWP of the serving BS 111a and UE 101, and the UE 101 performs the measurement procedure based on a random selection of the CD-SSB or NCD-SSB. In the third option 506, the UE 101 can select one of the CD-SSB or NCD-SSB in a flexible manner and saves power and resources by avoiding RF tuning to detect the SSB since the SSB already resides in the active BWP of the UE 101.

In a fourth option 508, that can be preconfigured at the UE 101, the CD-SSB and NCD-SSB are in the active BWP of the serving BS 111a and UE 101, and the UE 101 performs the measurement procedure based on the CD-SSB. In the fourth option 508, the UE 101 may not need to perform RF tuning to obtain the CD-SSB because the CD-SSB is already in the active BWP of the UE 101. Thus, the UE 101 conserves resources and selects the CD-SSB that includes full SSB information for the measurement procedure.

In a fifth option 510, that can be indicated by the serving BS 111a, the UE 101 performs the measurement procedure based on one of the CD-SSB or NCD-SSB indicated by the serving BS 111a. The fifth option 510 can correspond to events 304 and 308 of FIG. 3. The serving BS 111a can send the SSB type indication to the UE 101 in dedicated RRC signaling. For example, the MeasConfig information element can include a ssb-TypeForThreshold element within the s-MeasureConfig element where the ssb-TypeForThreshold element identifies the SSB type (e.g. CD-SSB or NCD-SSB). In another example, the MeasConfig information element can include a ssb-TypeForThreshold element within the MeasureConfig information element where the ssb-TypeForThreshold element identifies the SSB type (e.g. CD-SSB or NCD-SSB). The fifth option 510 allows the serving BS 111a to designate the SSB type for the measurement procedure based on the serving BS 111a knowledge of UE 101 capability and resource allocation of SSBs to best optimize network signaling and mobility performance. As such, the serving BS 111a can indicate the CD-SSB or NCD-SSB based on a configuration of the power levels associated the CD-SSB or NCD-SSB to trigger neighbor BS 111b measurements according to network optimization or mobility performance.

In a sixth option 512, the UE 101 performs the measurement procedure based on a SSB (e.g. CD-SSB or NCD-SSB) configured in a measurement object of the serving BS 111a. As such, SSB type can be UE 101 specific and received in dedicated RRC signaling. Thus the RRC signaling includes one of the CD-SSB or NCD-SSB associated with a serving cell measurement object, and the UE 101 uses one of the CD-SSB or NCD-SSB for the measurement procedure.

In a seventh option 514, that can be preconfigured at the UE 101, the UE 101 performs the measurement procedure based on the SSB (e.g. CD-SSB or NCD-SSB) used to determine an intra-frequency measurement. As such, the UE 101 determines intra-frequency measurements by using one of the CD-SSB or NCD-SSB, and one of the CD-SSB or NCD-SSB are an intra-frequency SSB common to the serving BS 111a and the neighbor BS 111b (e.g. common to the serving cell SSB and neighbor cell SSB). In this option, the SSB (CD-SSB or NCD-SSB) can further be in an intra-frequency of the active BWP of the UE 101. Thus, the UE 101 does not need to perform RF tuning to measurement the SSB and thus conserves resources and signaling.

In an eighth option 516, that can be indicated by the serving BS 111a, the serving BS 111a configures a same power level and beam for the CD-SSB and NCD-SSB. As such, the UE 101 detects the CD-SSB and NCD-SSB in a same beam with the same power level from the same cell (e.g. BS 111a). The BS 111a configuring a same power level and beam for the CD-SSB and NCD-SSB simplifies the UE 101 determination process for which SSB to use. When the UE 101 detects both SSB types in this manner, the UE can perform the measurement procedure based on a random selection of the CD-SSB or NCD-SSB.

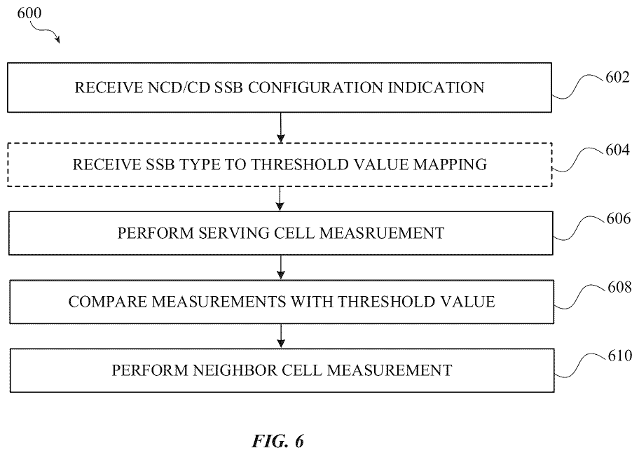

FIG. 6 illustrates a flow diagram of an example method 600 for neighbor cell measurements based on a serving cell measurement value associated with NCD-SSB/CD-SSB configurations for a UE. The example method 600 may be performed, for example, by the UE 101 of FIGS. 2-3.

At 602, the method includes receiving an indication of a NCD-SSB and CD-SSB configuration of a network. The indication communicating to the UE that different SSB types are discoverable by serving and neighboring BSs. FIG. 2 at 206 and FIG. 3, at 306 correspond to some aspects of act 602.

At 604, the method includes optionally receiving an indication of the SSB type to threshold value mapping for a measurement procedure. FIG. 3 at 308, FIG. 4 at fifth option 410 and seventh option 414, and FIG. 5 at fifth option 510 and eighth option 516 correspond to some aspects of act 604.

At 606, the method includes performing a measurement procedure including a serving cell (e.g. serving BS) SSB based measurement. The measurement procedure obtains a cell measurement value associated with a SSB type. The cell measurement value associated with the SSB type can correspond to the indicated SSB type from act 604, or a preconfigured or UE configured SSB type. FIG. 2 at 208, FIG. 3 at 310, FIGS. 4 at 402, 404, 406, 408, and 412, and FIGS. 5 at 502, 504, 506, 508, 512, and 514 correspond to some aspects of act 606.

At 608, the method includes comparing the cell measurement value and the threshold value. FIG. 2 at 208 and FIG. 3 at 312 correspond to some aspects of act 608.

At 610, the method includes performing neighbor cell measurements when the measurement value associated with the SSB type does not satisfy the threshold value. The neighbor cell (e.g. neighbor BS) measurement can be an intra-frequency, inter-frequency, or an inter-RAT measurement. FIG. 2 at 210 and FIG. 3 at 314 correspond to some aspects of act 610.

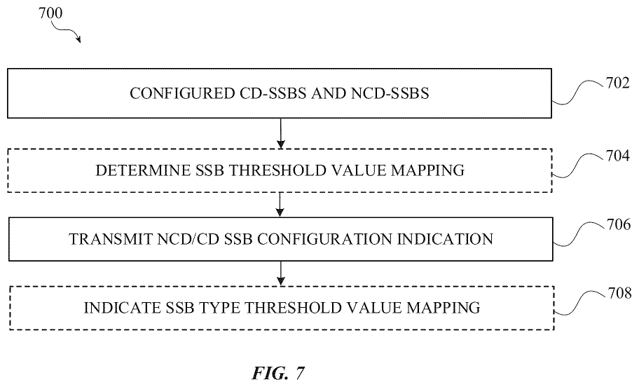

FIG. 7 illustrates a flow diagram of an example method 700 for neighbor cell measurements based on a serving cell measurement value associated with NCD-SSB/CD-SSB configurations for a BS. The example method 600 may be performed, for example, by the BS 111a of FIGS. 2-3.

At 702, the method includes configuring CD-SSBs and NCD-SSBs for beams of the BS. The different SSB types providing SSB resources for different kinds of UE capabilities. FIG. 2 at 206 and FIG. 3. at 302 correspond to some aspects of act 602.

At 704, the method includes optionally determining a mapping of threshold values associated with the SSB type (e.g. CD-SSB or NCD-SSB). The mapping indicates what SSB type and measurement values correspond to threshold values for a measurement procedure that can trigger neighbor cell measurements for a UE. FIG. 3 at 304, FIGS. 4 at 410 and 414, and FIGS. 5 at 510 and 516 correspond to some aspects of act 704.

At 706, the method includes transmitting an indication of the CD-SSB and NCD-SSB configuration. The indication indicating that different types of SSBs are configured by the BS. FIG. 2 at 206 and FIG. 3 at 306 correspond to some aspects of act 706.

At 708, the method includes optionally transmitting an indication of the SSB type and threshold value mapping of act 704. FIG. 3 at 308 corresponds to some aspects of act 708.

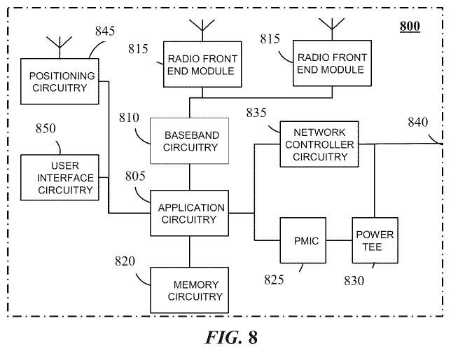

FIG. 8 illustrates an example of infrastructure equipment 800 in accordance with various aspects. The infrastructure equipment 800 (or “system 800”) may be implemented as a base station, radio head, RAN node such as the BS 111 of FIG. 1 and/or any other element/component/device discussed herein. In other examples, the system 800 could be implemented in or by a UE such as UE 101 of FIG. 1. In yet other aspects, some features of the system 800 could be implemented in or by serving BS 111a of FIG. 2 or 3 or neighbor BS 111b of FIG. 2.

The system 800 includes application circuitry 805, baseband circuitry 810, one or more radio front end modules (RFEMs) 815, memory circuitry 820 (including a memory interface), power management integrated circuitry (PMIC) 825, power tee circuitry 830, network controller circuitry 835, network interface connector 840, satellite positioning circuitry 845, and user interface 850. In some aspects, the device of system 800 may include additional elements/components/devices such as, for example, memory/storage, display, camera, sensor, or input/output (I/O) interface. In other aspects, the components/devices described below may be included in more than one device. For example, said circuitries may be separately included in more than one device for CRAN, vBBU, or other like implementations.

The baseband circuitry 810 can be used to configure the NCD-SSB and CD-SSB measurement link information and determine the SSB type to threshold value mapping and transmit an indication thereof by serving BS 111a described herein. Baseband circuitry 810 can be used to receive the indication of NCD/CD-SSB configuration and the SSB type to threshold value mapping or other signaling for the UE 101. Baseband circuitry 810 can be used to trigger the measurement procedure and perform serving cell or neighbor cell measurements from the UE 101.

Application circuitry 805 includes circuitry such as, but not limited to one or more processors (or processor cores), processing circuitry, cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 805 may be coupled with or may include memory/storage elements/components/devices and may be configured to execute instructions stored in the memory/storage to enable various applications or operating systems to run on the system 800. In some implementations, the memory/storage elements/components/devices may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

Application circuitry 805 can be used to determine or generate the NCD-SSB and CD-SSB by the serving BS 111a. Application circuitry 805 can be used to perform the measurement procedure by the UE 101. Memory circuitry 820 can store one or more of the above features for UE 101, serving BS 111a, or associated BS 111b.

The processor(s) of application circuitry 805 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some aspects, the application circuitry 805 may comprise, or may be, a special-purpose processor/controller to operate according to the various aspects herein. As examples, the processor(s) of application circuitry 805 may include one or more Apple® processors, Intel® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium(™), Inc.; a MIPS-based design from MIPS Technologies, Inc. such as MIPS Warrior P-class processors; and/or the like. In some aspects, the system 800 may not utilize application circuitry 805, and instead may include a special-purpose processor/controller to process IP data received from an EPC or 5GC, for example.

User interface 850 may include one or more user interfaces designed to enable user interaction with the system 800 or peripheral component or device interfaces designed to enable peripheral component or device interaction with the system 800. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component or device interfaces may include, but are not limited to, a nonvolatile memory port, a universal serial bus (USB) port, an audio jack, a power supply interface, etc.

The components or devices shown by FIG. 8 may communicate with one another using interface circuitry, that is communicatively coupled to one another, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

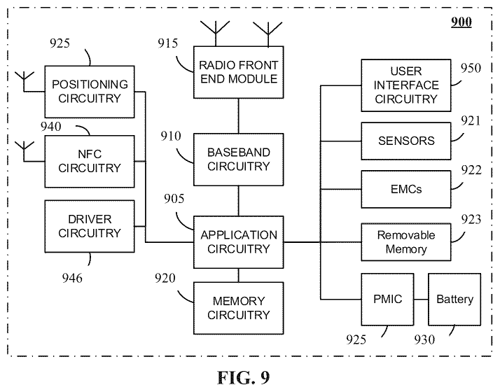

FIG. 9 illustrates an example of a platform 900 (or “device 900”) in accordance with various aspects. In aspects, the platform 900 may be suitable for use as the UE 101 of FIG. 1 or FIG. 2, and/or any other element/component/device discussed herein such as the BS 111a, 111b of FIG. 1, serving BS 111a of FIGS. 2-3 or the neighbor BS 111b of FIG. 2. The platform 900 may include any combinations of the components or devices shown in the example. The components or devices of platform 900 may be implemented as integrated circuits (ICs), portions thereof, discrete electronic devices, or other modules, logic, hardware, software, firmware, or a combination thereof adapted in the platform 900, or as components or devices otherwise incorporated within a chassis of a larger system. The block diagram of FIG. 9 is intended to show a high level view of components or devices of the platform 900. However, some of the components or devices shown may be omitted, additional components or devices may be present, and different arrangement of the components or devices shown may occur in other implementations.

Application circuitry 905 includes circuitry such as, but not limited to one or more processors (or processor cores), memory circuitry 920 (which includes a memory interface), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 905 may be coupled with or may include memory/storage elements/component/device and may be configured to execute instructions stored in the memory/storage to enable various applications or operating systems to run on the system 900. In some implementations, the memory/storage elements/components/devices may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

Application circuitry 905 can be used to determine or generate one or more of the NCD-SSB or CD-SSB or determine the SSB to threshold value mapping for the serving BS 111a. The Application circuitry 905 can be used to trigger the measurement procedure, or perform serving cell SSB measurements, or perform neighbor cell measurements for the UE 101. Memory circuitry 920 can store one or more of the above features for UE 101, serving BS 111a, or neighbor BS 111b.

As examples, the processor(s) of application circuitry 905 may include a general or special purpose processor, such as an A-series processor (e.g., the A13 Bionic), available from Apple® Inc., Cupertino, CA or any other such processor. The processors of the application circuitry 905 may also be one or more of Advanced Micro Devices (AMD) Ryzen® processor(s) or Accelerated Processing Units (APUs); Core processor(s) from Intel® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 905 may be a part of a system on a chip (SoC) in which the application circuitry 905 and other components or devices are formed into a single integrated circuit, or a single package.

The baseband circuitry or processor 910 may be implemented, for example, as a solder-down substrate including one or more integrated circuits, a single packaged integrated circuit soldered to a main circuit board or a multi-chip module containing two or more integrated circuits. Furthermore, the baseband circuitry or processor 910 may cause transmission of various resources.

The baseband circuitry 910 can be used to transmit the indication of NCD/CD-SSB configuration or an indication of the SSB type to threshold mapping from the serving BS 111a described herein. Baseband circuitry 910 can be used to receive the indication of NCD/CD-SSBS configuration or an indication of the SSB type to threshold mapping for the UE 101.

The platform 900 may also include interface circuitry (not shown) that is used to connect external devices with the platform 900. The interface circuitry may communicatively couple one interface to another. The external devices CONNECTED to the platform 900 via the interface circuitry include sensor circuitry 921 and electro-mechanical components (EMCs) 922, as well as removable memory devices coupled to removable memory circuitry 923.

A battery 930 may power the platform 900, although in some examples the platform 900 may be mounted deployed in a fixed location, and may have a power supply coupled to an electrical grid. The battery 930 may be a lithium ion battery, a metal-air battery, such as a zinc-air battery, an aluminum-air battery, a lithium-air battery, and the like. In some implementations, such as in V2X applications, the battery 930 may be a typical lead-acid automotive battery.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or examples of the disclosure herein. Also, one or more of the acts depicted herein may be carried out in one or more separate acts and/or phases. In some examples, the methods illustrated above may be implemented in a computer readable medium or a non-transitory computer readable medium using instructions stored in a memory. Many other examples and variations are possible within the scope of the claimed disclosure.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components or devices, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units. The processor or baseband processor can be configured to execute instructions described herein.

A UE or a BS, for example the UE 101 or BS 111 of FIG. 1 can comprise a memory interface and processing circuitry communicatively coupled to the memory interface configured to execute instructions described herein.

Examples (aspects) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to aspects and examples described herein.

Example 1 is a baseband processor of a user equipment (UE), comprising: one or more processors configured to: receive an indication of a non-cell-defined (NCD)-synchronization signal block (SSB) (NCD-SSB) and a cell-defined (CD)-SSB (CD-SSB) configuration; perform a measurement procedure to obtain a cell measurement value associated with a SSB wherein the SSB is one of the NCD-SSB or the CD-SSB; compare the cell measurement value with a threshold value; and perform measurement of a neighbor cell when the cell measurement value does not satisfy the threshold value.

Example 2 is the baseband processor of example 1, wherein the SSB for the measurement procedure is the CD-SSB.

Example 3 is the baseband processor of example 2, wherein the CD-SSB is at least partially comprised in a bandwidth part (BWP) that is other than an active BWP; and the one or more processors are further configured to: perform a radio frequency (RF) tuning procedure to tune to a frequency point of the CD-SSB.

Example 4 is the baseband processor of example 1, wherein the SSB for the measurement procedure is one of the NCD-SSB or CD-SSB comprised in a bandwidth part (BWP) of control resource set (CORESET) or paging.

Example 5 is the baseband processor of example 1, further configured to receive indication of the SSB for the measurement procedure.

Example 6 is the baseband processor of example 5, wherein the received indication of the SSB for the measurement procedure is received in dedicated radio resource control (RRC) signaling or a system information (SI) signaling.

Example 7 is the baseband processor of example 6, wherein the measurement procedure includes a plurality of cell measurement values associated with a plurality of SSBs and a plurality of associated threshold values; the received indication of the SSB for the measurement procedure includes the plurality of SSBs, wherein the plurality of SSBs are different from one another; the measurement procedure is performed to obtain the plurality of cell measurement values associated with the plurality of SSBs; and the measurement of the neighbor cell is performed when the plurality of cell measurement values does not satisfy the plurality of associated threshold values.

Example 8 is the baseband processor of example 1, wherein the SSB for the measurement procedure is a SSB associated with an intra-frequency measurement object.

Example 9 is the baseband processor of example 1, wherein the CD-SSB and NCD-SSB are received in a same cell with a same power level and same beam; and the processors are further configured to randomly select one of the CD-SSB or the NCD-SSB for the measurement procedure.

Example 10 is an apparatus of a user equipment (UE), comprising: one or more processors configured to: receive an indication that a network is configured for a non-cell-defined (NCD)-synchronization signal block (SSB) (NCD-SSB) and a cell-defined (CD)-SSB (CD-SSB); perform a measurement procedure to obtain a cell measurement value associated with the NCD-SSB or the CD-SSB; compare the cell measurement value with a threshold value; and perform measurement of a neighbor cell or a handover procedure when the cell measurement value does not satisfy the threshold value.

Example 11 is the apparatus of example 10, wherein the SSB for the measurement procedure is a SSB comprised in an active bandwidth part (BWP) of a serving cell.

Example 12 is the apparatus of example 10, further configured to receive both the CD-SSB and NCD-SSB within an active bandwidth part (BWP) of a serving cell.

Example 13 is the apparatus of example 12, further configured to randomly select one of the received CD-SSB or NCD-SSB for the measurement procedure.

Example 14 is the apparatus of example 12, further configured to select the received CD-SSB for the measurement procedure.

Example 15 is the apparatus of example 10, receive radio resource control (RRC) signaling including one of the CD-SSB or NCD-SSB associated with a serving cell measurement object, and selecting one of the CD-SSB or NCD-SSB for the measurement procedure.

Example 16 is the apparatus of example 10, wherein the one or more processors are configured to: determine intra-frequency measurements by using one of the CD-SSB or NCD-SSB, wherein one of the CD-SSB or NCD-SSB are an intra-frequency SSB common to a serving cell SSB and a neighboring cell SSB; and selecting one of the CD-SSB or NCD-SSB that is the intra-frequency SSB for the measurement procedure.

Example 17 is the apparatus of any of examples 10-16, wherein the UE is a radio resource control (RRC) CONNECTED mode.

Example 18 is a baseband processor of a base station (BS), comprising: one or more processors configured to: transmit an indication that the BS is configured for a non-cell-defining (NCD)-synchronization signal block (SSB) (NCD-SSB) and a cell-defining (CD)-SSB (CD-SSB);determine a threshold value associated with one or more of the NCD-SSB or CD-SSB; and transmit the threshold value and the associated one or more of the NCD-SSB or CD-SSB.

Example 19 is the baseband processor of example 18, wherein the associated one or more of the NCD-SSB or CD-SSB are comprised in system information signaling.

Example 20 is the baseband processor of example 18, wherein the associated one or more of the NCD-SSB or CD-SSB are comprised in dedicated radio resource control (RRC) signaling.

Example 21 is the baseband processor of example 18, wherein the CD-SSB and NCD-SSB are transmitted in a same beam with a same power level; and the CD-SSB and NCD-SSB are associated with the threshold value.

A method as substantially described herein with reference to each or any combination substantially described herein, comprised in examples 1-21, and in the Detailed Description.

A non-transitory computer readable medium as substantially described herein with reference to each or any combination substantially described herein, comprised in examples 1-21, and in the Detailed Description.

A wireless device configured to perform any action or combination of actions as substantially described herein, comprised in examples 1-21, and in the Detailed Description.

An integrated circuit configured to perform any action or combination of actions as substantially described herein, comprised in examples 1-21, and in the Detailed Description.

An apparatus configured to perform any action or combination of actions as substantially described herein, comprised in examples 1-21, and in the Detailed Description.

A baseband processor configured to perform any action or combination of actions as substantially described herein, comprised in examples 1-21, and in the Detailed Description.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communication media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal or apparatus.

In this regard, while the disclosed subject matter has been described in connection with various aspects and corresponding Figures, where applicable, it is to be understood that other similar aspects can be used or modifications and additions can be made to the described aspects for performing the same, similar, alternative, or substitute function of the disclosed subject matter without deviating therefrom. Therefore, the disclosed subject matter should not be limited to any single aspect described herein, but rather should be construed in breadth and scope in accordance with the appended claims below.

In particular regard to the various functions performed by the above described components or devices (assemblies, devices, circuits, systems, etc.), the terms (including a reference to a “means”) used to describe such components or devices are intended to correspond, unless otherwise indicated, to any component, device, or structure which performs the specified function of the described component or device (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

The present disclosure is described with reference to the attached drawing figures, wherein like reference numerals are used to refer to like elements, devices, or components throughout, and wherein the illustrated structures and devices are not necessarily drawn to scale. As utilized herein, terms “device,” “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable or non-transitory computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some aspects, the circuitry can be implemented in, or functions associated with the circuitry can be implemented by, one or more software or firmware modules. In some aspects, circuitry can include logic, at least partially operable in hardware.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor of a user equipment (UE), comprising:
one or more processors configured to:
receive an indication of a non-cell-defined (NCD)-synchronization signal block (SSB) (NCD-SSB) and a cell-defined (CD)-SSB (CD-SSB) configuration;
perform a measurement procedure to obtain a cell measurement value associated with a SSB wherein the SSB is one of the NCD-SSB or the CD-SSB;
compare the cell measurement value with a threshold value; and
perform measurement of a neighbor cell when the cell measurement value does not satisfy the threshold value.

2. The baseband processor of claim 1, wherein the SSB for the measurement procedure is the CD-SSB.

3. The baseband processor claim 2, wherein the CD-SSB is at least partially comprised in a bandwidth part (BWP) that is other than an active BWP; and the one or more processors are further configured to:
perform a radio frequency (RF) tuning procedure to tune to a frequency of the CD-SSB.

4. The baseband processor of claim 1, wherein the SSB for the measurement procedure is one of the NCD-SSB or CD-SSB comprised in a bandwidth part (BWP) of a control resource set (CORESET) or a paging resource.

5. The baseband processor of claim 1, further configured to receive indication of the SSB for the measurement procedure.

6. The baseband processor of claim 5, wherein the received indication of the SSB for the measurement procedure is received in a dedicated radio resource control (RRC) signaling or a system information (SI) signaling.

7. The baseband processor of claim 6, wherein the measurement procedure includes a plurality of cell measurement values associated with a plurality of SSBs and a plurality of associated threshold values;
the received indication of the SSB for the measurement procedure includes the plurality of SSBs, wherein the plurality of SSBs are different from one another;
the measurement procedure is performed to obtain the plurality of cell measurement values associated with the plurality of SSBs; and
the measurement of the neighbor cell is performed when the plurality of cell measurement values does not satisfy the plurality of associated threshold values.

8. The baseband processor of claim 1, wherein the SSB for the measurement procedure is a associated with an intra-frequency measurement object.

9. The baseband processor of claim 1, wherein the CD-SSB and NCD-SSB are received in a same cell with a same power level and same beam; and
the processors are further configured to randomly select one of the CD-SSB or the NCD-SSB for the measurement procedure.

10. An user equipment (UE), comprising:
a memory circuit; and
one or more processors communicatively coupled to the memory circuit, and configured to:
receive an indication that a network is configured for a non-cell-defined (NCD)-synchronization signal block (SSB) (NCD-SSB) and a cell-defined (CD)-SSB (CD-SSB);
perform a measurement procedure to obtain a cell measurement value associated with the NCD-SSB or the CD-SSB;
compare the cell measurement value with a threshold value; and
perform measurement of a neighbor cell or a handover procedure when the cell measurement value does not satisfy the threshold value.

11. The UE of claim 10, wherein the SSB for the measurement procedure is comprised in an active bandwidth part (BWP) of a serving cell.

12. The UE of claim 10, further configured to receive both the CD-SSB and NCD-SSB within an active bandwidth part (BWP) of a serving cell.

13. The UE of claim 12, further configured to randomly select one of the received CD-SSB or NCD-SSB for the measurement procedure.

14. The UE of claim 12, further configured to select the received CD-SSB for the measurement procedure.

15. The UE of claim 10, further configured to receive radio resource control (RRC) signaling that includes one of the CD-SSB or NCD-SSB associated with a serving cell measurement object, and selecting one of the CD-SSB or NCD-SSB for the measurement procedure.

16. The UE of claim 10, wherein the one or more processors are configured to:
determine intra-frequency measurements by using one of the CD-SSB or NCD-SSB, wherein one of the CD-SSB or NCD-SSB are an intra-frequency SSB common to a serving cell SSB and a neighboring cell SSB; and
selecting one of the CD-SSB or NCD-SSB that is the intra-frequency SSB for the measurement procedure.

17. A base station (BS), comprising:
a memory circuit; and
one or more processors, coupled to the memory circuit, and configured to:
transmit an indication that the BS is configured for a non-cell-defining (NCD)-synchronization signal block (SSB) (NCD-SSB) and a cell-defining (CD)-SSB (CD-SSB);
determine a threshold value associated with one or more of the NCD-SSB or CD-SSB; and
transmit, by a radio frequency (RF) circuitry, the threshold value and the associated one or more of the NCD-SSB or CD-SSB.

18. The BS of claim 17, wherein the associated one or more of the NCD-SSB or CD-SSB are comprised in system information signaling.

19. The BS of claim 17, wherein the associated one or more of the NCD-SSB or CD-SSB are comprised in dedicated radio resource control (RRC) signaling.

20. The BS of claim 17, wherein the CD-SSB and NCD-SSB are transmitted in a same beam with a same power level; and
the CD-SSB and NCD-SSB are associated with the threshold value.
